(19) United States
(12) Patent Application Publication
(10) Pub. No.: US 2015/0275577 A1
(43) Pub. Date: Oct. 1, 2015

(54) EMERGENCY ESCAPE SYSTEM FROM BUILDING

(71) Applicant: Byung-Yun CHUNG, Seoul (KR)

(72) Inventor: Byung-Yun CHUNG, Seoul (KR)

(21) Appl. No.: 14/668,375

(22) Filed: Mar. 25, 2015

(30) Foreign Application Priority Data
Mar. 26, 2014 (KR) 10-2014-0035517

(51) Int. Cl. E06C 1/34; A62B 5/00

(52) U.S. Cl. CPC E06C 1/34; A62B 5/00

(57) ABSTRACT

The inventive concepts relate to an emergency escape system from a building including a plurality of floors and openings horizontally arranged on each of the floors. The system includes a first supporting portion and a first handle portion. The first supporting portion is installed to be adjacent to a bottom end of each of the openings and extends in the horizontal direction. The first handle portion extends in the horizontal direction and is provided at a height corresponding to a height of a central portion of each of the openings.

### CROSS-REFERENCE TO RELATED APPLICATION

This U.S. non-provisional patent application claims priority under 35 U.S.C. §119 to Korean Patent Application No. 10-2014-0035517, filed on Mar. 26, 2014, in the Korean Intellectual Property Office, the disclosure of which is hereby incorporated by reference in its entirety.

### BACKGROUND

The inventive concepts relate to an emergency escape system from a building. More particularly, the inventive concepts relate to an emergency escape system that has a simple structure and is installed around windows and doors of a building. Anyone may quickly and stably escape in an emergency (e.g., a fire) by the emergency escape system without an additional tool and/or full knowledge of an additional method. In addition, anyone may also move to another floor through the emergency escape system according to the inventive concepts.

Ladders or towing ropes are installed on various buildings and/or apartments for emergency escape. However, these emergency escape devices may be additionally spread or unfolded or it is difficult to know how to use these emergency escape devices, so they may be hardly used in a real emergency.

In addition, since an additional space in which a person is temporarily evacuated from a danger may not exist and a person may escape from a corresponding floor to the ground by oneself, the old or weak or a child may fall during the escape.

Thus, availability and stability of conventional emergency escape devices may be very low against installation costs thereof. As a result, it is required to develop an emergency escape system that is capable of easily used by anyone and is inexpensive and simple.

### SUMMARY

Embodiments of the inventive concepts may provide an emergency escape system that has a simple structure and is capable of being installed on an outer wall of a building.

Embodiments of the inventive concepts may also provide an emergency escape system capable of easily and stably rescuing people from danger.

Embodiments of the inventive concepts may further provide an emergency escape system capable of reducing an evacuation time.

Embodiments of the inventive concepts may further provide an emergency escape system capable of being easily installed and of reducing installation costs.

Embodiments of the inventive concepts may further provide an emergency escape system capable of improving efficiency of evacuation.

Embodiments of the inventive concepts provide an emergency escape system from a building including a plurality of floors and openings arranged in a horizontal direction on each of the floors. The emergency escape system includes: a plurality of first supporting portions, each of the first supporting portions installed to be adjacent to a bottom end of each of the openings, and each of the first supporting portions extending in the horizontal direction; and a first handle portion extending in the horizontal direction, the first handle portion provided at a height corresponding to a height of a central portion of each of the openings.

In an embodiment, the first handle portion may be spaced apart from the first supporting portion by a distance ranging from 30% to 60% of a height of the opening.

In an embodiment, rounded concave portions and rounded convex portions may be alternately formed on a surface of the first handle portion, and an anti-slip coating layer may be formed on the surface of the first handle portion.

In an embodiment, the emergency escape system may further include: a plurality of second supporting portions, each of the second supporting portions installed to be adjacent to a top end of each of the openings, and each of the second supporting portions extending in the horizontal direction; and a second handle portion installed at a side of at least one of the openings, the second handle portion extending in a vertical direction. A top end of the second handle portion may be located at a height corresponding to at least a height at which the second supporting portion is located, and a bottom end of the second handle portion may be located at a height corresponding to at least a height at which the first supporting portion is located.

In an embodiment, each of the first and second supporting portions may be spaced apart from the opening by a distance of 4 centimeters to 11 centimeters.

In an embodiment, a width of each of the first and second supporting portions may be in a range of 12 centimeters to 36 centimeters.

In an embodiment, a plurality of holes, depressions and protrusions may be alternately formed on a top surface of each of the first and second supporting portions, and an anti-slip coating layer may be formed on the top surface of each of the first and second supporting portions.

In an embodiment, a top surface of each of the first and second supporting portions may have a gradient toward the opening.

In an embodiment, each of the first and second handle portions may have a pipe shape of which a diameter is in a range of 2 centimeters to 6 centimeters.

In an embodiment, the emergency escape system may further include: a protector including: a hook capable of being hung on the first and second handle portions; and a belt capable of fixing the human body.

In an embodiment, step plates may be provided on one sidewall of a surface of the second handle portion and may be vertically spaced apart from each other. Handles may be provided on both sidewalls of the second handle portion which are perpendicular to the one sidewall provided with the step plates. The handles may be vertically spaced apart from each other.

In an embodiment, rounded concave portions and rounded convex portions may be alternately formed on a surface of the second handle portion, and the surface of the second handle portion may be coated with an anti-slip coating layer formed of an epoxy.

### BRIEF DESCRIPTION OF THE DRAWINGS

The inventive concepts will become more apparent in view of the attached drawings and accompanying detailed description.

FIG. I is a diagram illustrating an emergency escape system from a building according to example embodiments of the inventive concepts; and

FIG. 2 is a diagram illustrating one unit of an emergency escape system from a building according to example embodiments of the inventive concepts.

### DETAILED DESCRIPTION OF THE EMBODIMENTS

The inventive concepts will now be described more fully hereinafter with reference to the accompanying drawings, in which exemplary embodiments of the inventive concepts are shown. The advantages and features of the inventive concepts and methods of achieving them will be apparent from the following exemplary embodiments that will be described in more detail with reference to the accompanying drawings. It should be noted, however, that the inventive concepts are not limited to the following exemplary embodiments, and may be implemented in various forms. Accordingly, the exemplary embodiments are provided only to disclose the inventive concepts and let those skilled in the art know the category of the inventive concepts. In the drawings, embodiments of the inventive concepts are not limited to the specific examples provided herein and are exaggerated for clarity.

The terminology used herein is for the purpose of describing particular embodiments only and is not intended to limit the invention. As used herein, the singular terms “a,” “an” and “the” are intended to include the plural forms as well, unless the context clearly indicates otherwise.

As used herein, the term “and/or” includes any and all combinations of one or more of the associated listed items. It will be understood that when an element is referred to as being “connected” or “coupled” to another element, it may be directly connected or coupled to the other element or intervening elements may be present.

Similarly, it will be understood that when an element such as a layer, region or substrate is referred to as being “on” another element, it can be directly on the other element or intervening elements may be present. In contrast, the term “directly” means that there are no intervening elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It will be also understood that although the terms first, second, third etc. may be used herein to describe various elements, these elements should not be limited by these terms. These terms are only used to distinguish one element from another element. Thus, a first clement in sonic embodiments could be termed a second clement in other embodiments without departing from the teachings of the present invention. Exemplary embodiments of aspects of the present inventive concepts explained and illustrated herein include their complementary counterparts. The same reference numerals or the same reference designators denote the same elements throughout the specification.

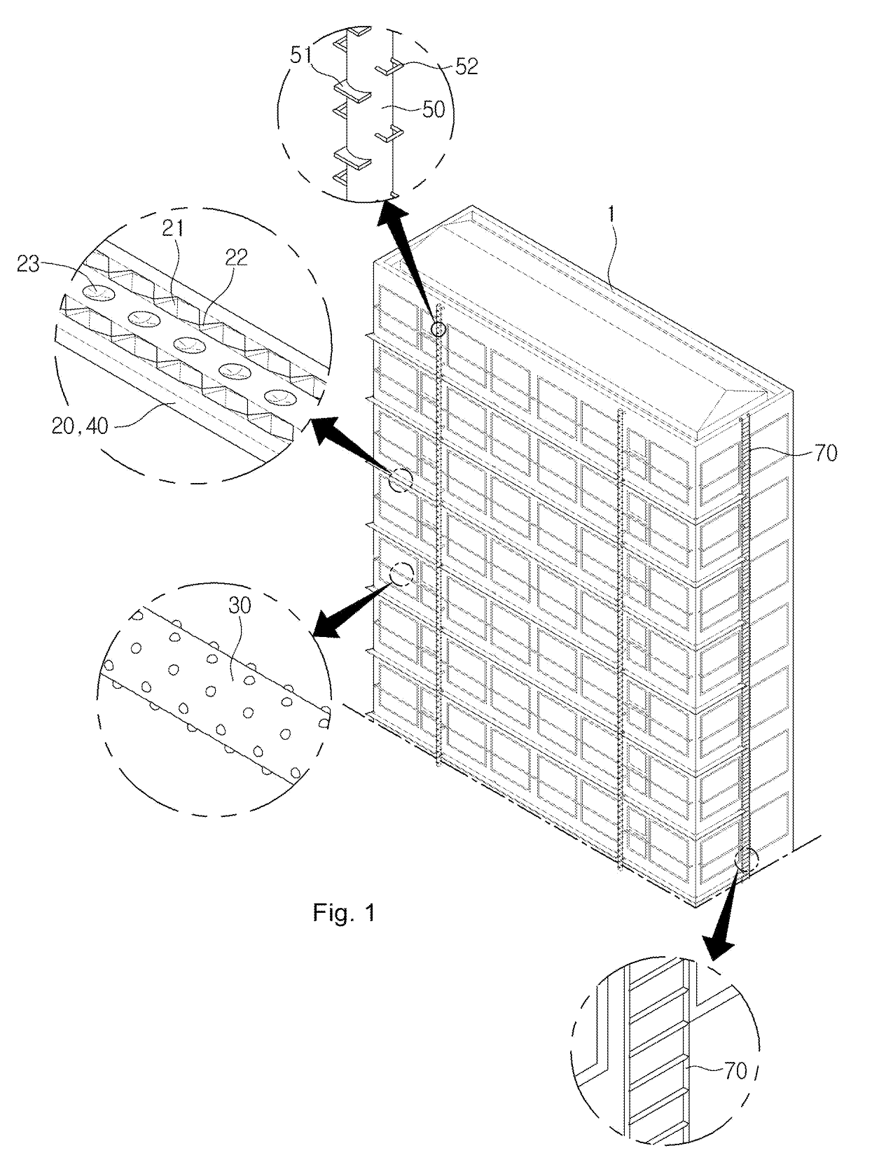

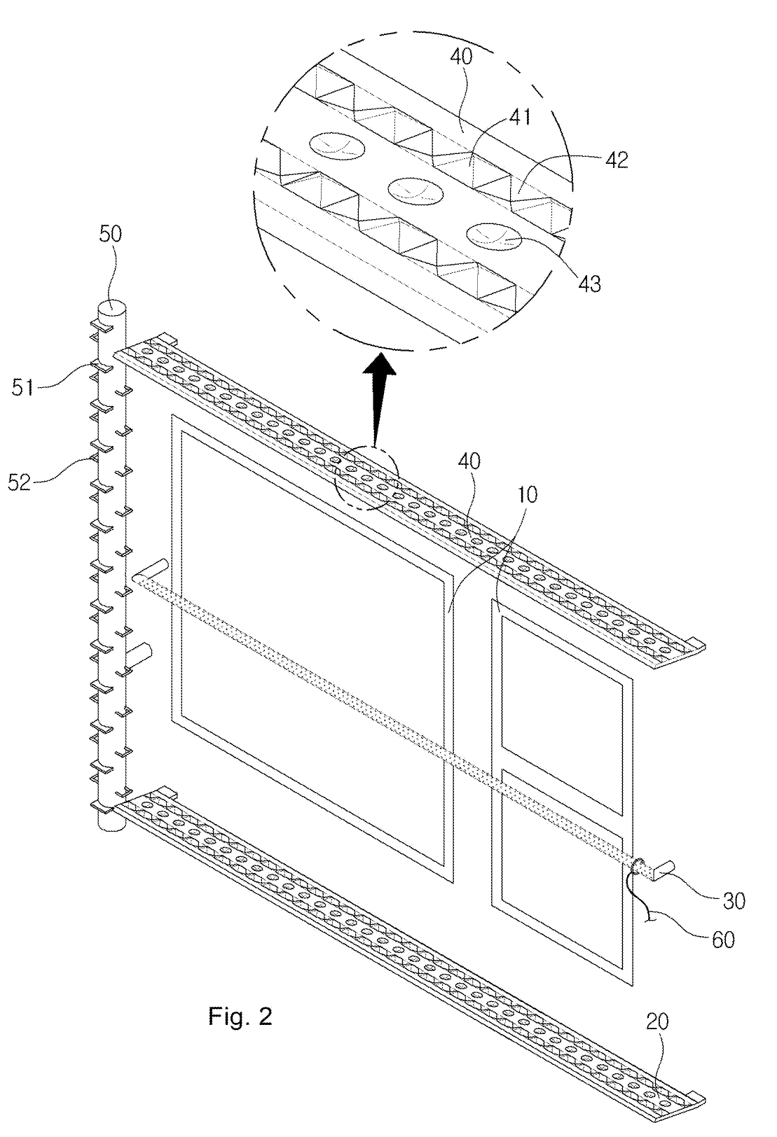

As illustrated in FIGS. 1 and 2, an emergency escape system according to embodiments of the inventive concepts may be installed on a building 1 that has a plurality of floors and openings 10 arranged on each of the floors in a horizontal direction. The emergency escape system may include supporting portions 20 and 40, a first handle portion 30, and a second handle portion 50.

The supporting portions 20 and 40 may be provided between the floors adjacent to each other and may extend along an arrangement direction of the openings 10 in the horizontal direction between the floors. Thus, the supporting portions 20 and 40 may be located to be respectively adjacent to a bottom end and a top end of the opening 10 on each of the floors except the uppermost floor. The supporting portions 20 and 40 may be attachable to and detachable from a wall of the building 1. The supporting portions 20 and 40 may act as foot plates on which people are movable outside the building 1 in the horizontal direction. Hereinafter, on each of the floors, the supporting portion 20 adjacent to the bottom end of the opening 10 is defined as a first supporting portion 20, and the supporting portion 40 adjacent to the top end of the opening 10 is defined as a second supporting portion 40.

The first supporting portion 20 may be installed in the horizontal direction on the outer wall of the building 1 which is located under the bottom end of each of the openings 10.

The opening 10 formed on the outer wall of the building 1 may mean an inter-floor entire portion including a region through which people move from the inside of the building 1 to the outside of the building 1. In embodiments of the inventive concepts, the opening 10 may include at least one of windows, doors, or verandas. In other words, if the opening 10 includes a door, the opening 10 may also include elements (e.g., windows) that surround the door and are closed. The opening 10 may include a plurality of windows or verandas or any combination thereof according to a size of the opening 10.

The second supporting portion 40 may be installed in the horizontal direction on the outer wall of the building 1 which is located on the top end of the opening 10. The second supporting portion 40 may be parallel to the first supporting portion 20 with the opening 10 interposed therebetween. The second supporting portion 40 may have the same structure as the first supporting portion 20.

Each of the first and second supporting portions 20 and 40 may be spaced apart from the opening 10 by a distance of 4 centimeters to 11 centimeters, and more particularly, by a distance of 6 centimeters to 8 centimeters. In an embodiment, each of the first and second supporting portions 20 and 40 may be spaced apart from the opening 10 by a distance of 7 centimeters. These numeral values of the distance were optimized in due consideration of movement efficiency of an ordinary person and a width of a foot of the ordinary person under conditions that foots of the ordinary person do not fall from the supporting portions 20 and 40 and foreign substances (e.g., snow and/or rain) penetrate the supporting portions 20 and 40. The numeral values of the distance were optimized by the inventor through various researches.

In addition, a width of each of the first and second supporting portions 20 and 40 may be in a range of 12 centimeters to 36 centimeters, and more particularly, in a range of 16 centimeters to 28 centimeters. In an embodiment, the width of each of the first and second supporting portions 20 and 40 may be 20 centimeters. The ordinary person may smoothly move on each of the first and second supporting portions 20 and 40 when the width of each of the first and second supporting portions 20 and 40 is equal to or greater than 50% (in particular, 80%) of a foot length of the ordinary person. Thus, the numeral values of the width were optimized in due consideration of the mean value of foot lengths of men and women.

Furthermore, the first and second supporting portions 20 and 40 may include a plurality of holes 23 and 43. If the various foreign substances (e.g., snow or rain) are piled up on the supporting portions 20 and 40, people may slip on the supporting portions. Thus, movement stability of people may be deteriorated. However, the holes 23 and 43 may prevent the various foreign substances from being piled up on the first and second supporting portions 20 and 40, so it is possible to prevent or minimize deterioration of the movement stability. In addition, the holes 23 and 43 may improve endurance of the supporting portions 20 and 40 from the wind outside upper floors.

Top surfaces of the first and second supporting portions 20 and 40 may be maintained in a horizontal state or may have a gradient toward the opening 10. The gradient of the top surfaces of the first and second supporting portions 20 and 40 may be in a range of 10 degrees to 30 degrees. In an embodiment, the gradient of the top surfaces of the first and second supporting portions 20 and 40 may be 15 degrees. If the gradient is smaller than 10 degrees, a removal effect of the foreign substances and a fall prevention effect may be insignificant. If the gradient is greater than 30 degrees, it may be difficult to balance the human body. Thus, the movement efficiency may be markedly reduced. Since the supporting portions 20 and 40 have the suitable gradient toward the opening 10, the center of gravity of the human body may move toward the first handle portion 30. Thus, stability may be increased and people may easily move.

In addition, depressions 22 and 42 and protrusions 21 and 41 that have angular shapes may be alternately formed on the top surfaces of the first and second supporting portions 20 and 40, and an anti-slip coating layer may be provided on the top surfaces of the first and second supporting portions 20 and 40. The anti-slip coating layer may be formed of an epoxy. The depressions 22 and 42, the protrusions 21 and 41, and the anti-slip coating layer may prevent foots of people from slipping, so it is possible to prevent people from falling from the supporting portions 20 and 40.

The angular depressions 22 and 42 and the angular protrusions 21 and 41 may be formed along a longitudinal direction of the first and second supporting portions 20 and 40. In addition, the depressions 22 and 42 and the protrusions 21 and 41 and the holes 23 and 43 may be alternately arranged. As a result, an anti-slip effect may be more increased.

The first handle portion 30 may be provided on each of the floors and on each of the openings 10, so people moving using the first supporting portion 20 as the foot plate may grip the first handle portion 30. The first handle portion 30 may extend in the horizontal direction and may be installed at a height corresponding to that of a central portion of the opening 10. The first handle portion 30 may be spaced apart from the first supporting portion 20 by a distance ranging from 30% to 60% of a height of the opening 10. More particularly, the first handle portion 30 may be spaced apart from the first supporting portion 20 by a distance ranging from 40% to 60% of the height of the opening 10. In an embodiment, the first handle portion 30 may be spaced apart from the first supporting portion 20 by the distance equal to 55% of the height of the opening 10. If the distance is smaller than 30% of the height of the opening 10, the first handle portion 30 may be too close to the first supporting portion 20. Thus, the first handle portion 30 may be too uncomfortable to grip, considering a height of an ordinary person. If the distance is greater than 60% of the height of the opening 10, the first handle portion 30 may be too close to the second supporting portion. Thus, the first handle portion 30 may also be too uncomfortable to grip. In addition, people may miss the first handle portion 30.

The first handle portion 30 may have a pipe shape of which a diameter may be in a range of 2 centimeters to 6 centimeters. More particularly, the diameter of the first handle portion 30 may be in a range of 3 centimeters to 5 centimeters. In an embodiment, the diameter of the first handle portion 30 may be 4 centimeters. If the diameter is smaller than 2 centimeters or greater than 6 centimeters, stability may be markedly deteriorated. The first handle portion 30 may be attachable to and detachable from the outer wall of the building 1.

The second handle portion 50 may be provided in plurality and may be installed on each of the floors. The second handle portion 50 may extend in a vertical direction. The second handle portion 50 may be installed at a side of the opening 10 or between the openings 10 adjacent to each other. A top end of each of the second handle portions 50 may be located at a height corresponding to a height at which the second supporting portion 40 is located, and a bottom end of each of the second handle portions 50 may be located at a height corresponding to a height at which the first supporting portion 20 is located.

The second handle portions 50 may be arranged in a line along the vertical direction from the first floor to the uppermost floor. The vertical directional arrangement of the second handle portions 50 may be provided in plurality along a circumference of the building 1. The second handle portions 50 may be provided for vertical movement and temporary rest.

The second handle portion 50 may have a cylindrical pipe shape or a quadrilateral pillar shape. The second handle portion 50 may be attachable to and detachable from the outer wall of the building 1.

At least two kinds of protrusions 51 and 52 may be formed on a surface of the second handle portion 50. One kind of protrusions 51 may be arranged along a longitudinal direction of the second handle portion 50 on one sidewall of the surface of the second handle portion 50. The protrusions 51 may he vertically spaced apart from each other. The one kind of protrusions 51 may be provided as step boards on which a person steps to ascend or descend along the second handle portion 50. A shape of the protrusion 51 may be various. A protruding length of the protrusion 51 may be in a range of 7 centimeters to 12 centimeters. This range of protruding length is a range optimized in due consideration of the exterior of the building 1 and another kind of protrusions 52. In other words, the protrusions 51 may sufficiently act as the step boards when the protruding lengths of the protrusions 51 are in the range of 7 centimeters to 12 centimeters.

Another kind of protrusions 52 may be provided as handles and may be provided on the both sidewalls of the second handle portion 50 which are perpendicular to the one sidewall of second handle portion 50. A person stepping on the protrusion 51 may grip the protrusions 52 with both hands.

The protrusions 51 and 52 formed on the second handle portion 50 may minimize disfigurement of the building 1 and may improve efficiency and stability of vertical movement of people.

Rounded concave portions and convex portions may be alternately formed on surfaces of the first and second handle portions 30 and 50, and an anti-slip coating layer may be formed on the surface of each of the first and second handle portions 30 and 50. The anti-slip coating layer may be formed of an epoxy. The rounded concave and convex portions may be formed in a region being in contact with the palm, so supporting force may be increased. In addition, an anti-slip effect may be improved by the rounded concave and convex portions and the anti-slip coating layer.

The emergency escape system may further include a protector 60 that includes a hook capable of being hung on the first and second handle portions 30 and 50 and a belt capable of fixing the human body. The protector 60 may protect people from a dangerous situation (e.g., a misstep).

The first and second handle portions 30 and 50 may have pipe shapes as described above, so the protector 60 may use a hook attachable to and detachable from a pipe. A user may connect the hook to the first handle portion 30 or the second handle portion 50, so the stability of the user may be secured during movement. In addition, the user may move in at least one opening 10 without addition connection.

The emergency escape system may further include a ladder 70 that is additionally installed on a side surface of the building 1. In this case, the user may horizontally move to the ladder 70, so the user may be quickly evacuated through the ladder 70.

The first supporting portion 20 and the first handle portion 30 may constitute one unit, and the emergency escape system according to the inventive concepts may a plurality of the units. The plurality of units may be prefabricated to be attachable to and detachable from the building 1. Thus, sizes and positions of the units may be variously fabricated according to sizes of the openings 10.

In addition, a security problem of the building 1 may be solved by various methods. For example, a security sensor may be installed on at least one of the supporting portion and the handle portion to solve the security problem. Furthermore, colors and/or materials of the supporting portions and the handle portions may be variously realized to improve beauty of the exterior of the building 1.

According to embodiments of the inventive concepts, the emergency escape system having the simple structure may be installed on the outer wall of the building, so anyone may be quickly and stably evacuate or escape from the building without additional unfolding, an additional tool, and/or full knowledge of an additional method.

In addition, people may easily move to another floor and/or the next room through the emergency escape system according to the inventive concepts. Thus, people may easily move in up and down directions and right and left directions without an additional tool when the danger (e.g., a fire) locally occurs in a portion of the building.

Moreover, people may move directly to any one of sections near to a dangerous spot (e.g., the fire). Thus, even though people do not escape to the ground, people may be out of the danger zone.

Furthermore, the emergency escape system may have the triple anti-slip design and the protector suitable to the structures of the supporting portions and handle portions, so the danger such as the misstep may be prevented and the simple structure of the emergency escape system may be realized.

The elements of the emergency escape system may have the sizes and/or the arrangement which are optimized to the human body, and thus, anyone may easily and stably use the elements of the emergency escape system in an emergency. In addition, the evacuation time may be markedly reduced.

The elements of the emergency escape system may be prefabricated and may be easily installed. In addition, the emergency escape system may have low installation costs. Furthermore, the emergency escape system may be combined with the ladder installed in advance, so the evacuation efficiency may be more improved.

While the inventive concepts have been described with reference to example embodiments, it will be apparent to those skilled in the art that various changes and modifications may be made without departing from the spirits and scopes of the inventive concepts. Therefore, it should be understood that the above embodiments are not limiting, but illustrative. Thus, the scopes of the inventive concepts are to be determined by the broadest permissible interpretation of the following claims and their equivalents, and shall not be restricted or limited by the foregoing description.

What is claimed is:

1. An emergency escape system from a building including a plurality of floors and openings arranged in a horizontal direction on each of the floors, the emergency escape system comprising:
a plurality of first supporting portions, each of the first supporting portions installed to be adjacent to a bottom end of each of the openings, and each of the first supporting portions extending in the horizontal direction; and
a first handle portion extending in the horizontal direction, the first handle portion provided at a height corresponding to a height of a central portion of each of the openings.

2. The emergency escape system of claim 1, wherein the first handle portion is spaced apart from the first supporting portion by a distance ranging from 30% to 60% of a height of the opening.

3. The emergency escape system of claim 1, wherein rounded concave portions and rounded convex portions are alternately formed on a surface of the first handle portion, and wherein an anti-slip coating layer is formed on the surface of the first handle portion.

4. The emergency escape system of claim 1, further comprising:
a plurality of second supporting portions, each of the second supporting portions installed to be adjacent to a top end of each of the openings, and each of the second supporting portions extending in the horizontal direction; and
a second handle portion installed at a side of at least one of the openings on each of the floors, the second handle portion extending in a vertical direction,
wherein a top end of the second handle portion is located at a height corresponding to a height at which the second supporting portion is located, and
wherein a bottom end of the second handle portion is located at a height corresponding to a height at which the first supporting portion is located.

5. The emergency escape system of claim 4, wherein each of the first and second supporting portions is spaced apart from the opening by a distance of 4 centimeters to 11 centimeters.

6. The emergency escape system of claim 4, wherein a width of each of the first and second supporting portions is in a range of 12 centimeters to 36 centimeters.

7. The emergency escape system of claim 4, wherein a plurality of holes, depressions and protrusions are alternately formed on a top surface of each of the first and second supporting portions, and
wherein an anti-slip coating layer is formed on the top surface of each of the first and second supporting portions.

8. The emergency escape system of claim 4, wherein a top surface of each of the first and second supporting portions has a gradient toward the opening.

9. The emergency escape system of claim 4, wherein each of the first and second handle portions has a pipe shape of which a diameter is in a range of 2 centimeters to 6 centimeters.

10. The emergency escape system of claim 4, further comprising:
a protector including: a hook capable of being hung on the first and second handle portions; and a belt capable of fixing the human body.

11. The emergency escape system of claim 4, wherein step plates are provided on one sidewall of a surface of the second handle portion and are vertically spaced apart from each other,
wherein handles are provided on both sidewalls of the second handle portion which are perpendicular to the one sidewall provided with the step plates, and
wherein the handles are vertically spaced apart from each other.

12. The emergency escape system of claim 4, wherein rounded concave portions and rounded convex portions are alternately formed on a surface of the second handle portion, and
wherein the surface of the second handle portion is coated with an anti-slip coating layer formed of an epoxy.
